(19) United States
(12) Patent Application Publication
(10) Pub. No.: US 2026/0246122 A1
(43) Pub. Date: Aug. 20, 2026

(54) VEHICLE BATTERY APPARATUS AND METHOD THEREFOR

(71) Applicant: Knorr-Bremse AG, Munchen (DE)

(72) Inventors: Akshay Mishra, Kanpur (IN); Amit Babalal Nahar, Pune (IN)

(73) Assignee: Knorr-Bremse AG, Munchen (DE)

(21) Appl. No.: 19/170,563

(22) Filed: Apr. 4, 2025

(30) Foreign Application Priority Data
Feb. 17, 2025 (IN) 202511013551

(51) Int. Cl. H01M 50/597; B60R 16/033; G07C 5/08; H01M 10/48; H01M 50/249; H02H 7/18

(52) U.S. Cl. CPC H01M 50/597; B60R 16/033; G07C 5/0808; G07C 5/0825; H01M 10/488; H01M 50/249; H02H 7/18; H01M 2200/30; H01M 2220/20

(57) ABSTRACT

A vehicle battery apparatus is provided for a vehicle having redundant batteries and a reverse polarity protection circuit associated with each battery. The vehicle battery apparatus comprises an isolating circuit coupled between the reverse polarity protection circuits and a load that can be powered with forward current flow from the redundant batteries through the reverse polarity protection circuits. The isolating circuit is arranged to prevent reverse current flow through the reverse polarity protection circuits to the redundant batteries.

### BACKGROUND

The present application relates to vehicle battery systems, and is particularly directed to a vehicle battery apparatus and method therefor, such as for a heavy duty vehicle (e.g., a truck and/or trailer) having a redundant battery system.

A dual battery system is usually provided in a truck to ensure backup power in the event that one battery fails to supply power. In the event that one battery fails to supply power, the other battery can take over to maintain continuous operation and integrity of the system. In some trucks, the dual battery system has a reverse polarity protection mechanism to protect electronic components of the truck, including the batteries, from damage in the event that a battery is incorrectly connected (e.g., the terminals of a battery are improperly connected). The reverse polarity protection mechanism is usually designed to block current flow in the event of a battery being incorrectly connected.

Despite advances already made, those skilled in the art continue with research and development efforts in the field of dual battery systems with reverse polarity protection.

### SUMMARY

In accordance with one embodiment, a vehicle battery apparatus is provided for a vehicle having redundant batteries and a reverse polarity protection circuit associated with each battery. The vehicle battery apparatus comprises an isolating circuit coupled between the reverse polarity protection circuits and a load that can be powered with forward current flow from the redundant batteries through the reverse polarity protection circuits. The isolating circuit is arranged to prevent reverse current flow through the reverse polarity protection circuits to the redundant batteries.

In accordance with another embodiment, a vehicle battery apparatus comprises first and second batteries, and first and second reverse polarity protection circuits associated with the first and second batteries, respectively. The vehicle battery apparatus also comprises an isolating circuit coupled between the first and second reverse polarity protection circuits. The isolating circuit allows forward current flow from the first and second batteries through the first and second reverse polarity protection circuits and prevents reverse current flow through the first and second reverse polarity protection circuits to the first and second batteries.

In accordance with yet another embodiment, a vehicle battery apparatus comprises first and second batteries, and first and second reverse polarity protection circuits associated with the first and second batteries, respectively. The vehicle battery apparatus also comprises means for preventing current flow from each battery through the reverse polarity protection circuit of the other battery when the other battery is disconnected from its associated reverse polarity protection circuit.

In accordance with still another embodiment, a method is provided of operating a vehicle battery apparatus having at least two batteries and a reverse polarity protection circuit associated with each battery. The method comprises preventing current flow from a first battery through the reverse polarity protection circuit of a second battery when the second battery is disconnected from its associated reverse polarity protection circuit.

### BRIEF DESCRIPTION OF THE DRAWINGS

FIG. 1 shows a schematic block diagram of a vehicle embodying prior art redundant batteries with reverse polarity protection circuits.

FIG. 2 is similar to FIG. 1, and shows a schematic block diagram of a vehicle embodying an example vehicle battery apparatus in accordance with the present disclosure.

FIG. 2A shows a schematic circuit diagram of the vehicle battery apparatus of FIG. 2 embodying an example isolating circuit in accordance with the present disclosure.

FIG. 3 is a flow diagram depicting a method of operating the vehicle battery apparatus of FIG. 2 in accordance with an embodiment.

### DETAILED DESCRIPTION

The present application is directed to a vehicle battery apparatus and method therefor, such as for a heavy duty vehicle (e.g., a truck and/or trailer) having a redundant battery system. The specific construction of the vehicle battery apparatus may vary. It is to be understood that the disclosure below provides a number of embodiments or examples for implementing different features of various embodiments. Specific examples of components and arrangements are described to simplify the present disclosure. These are merely examples and are not intended to be limiting.

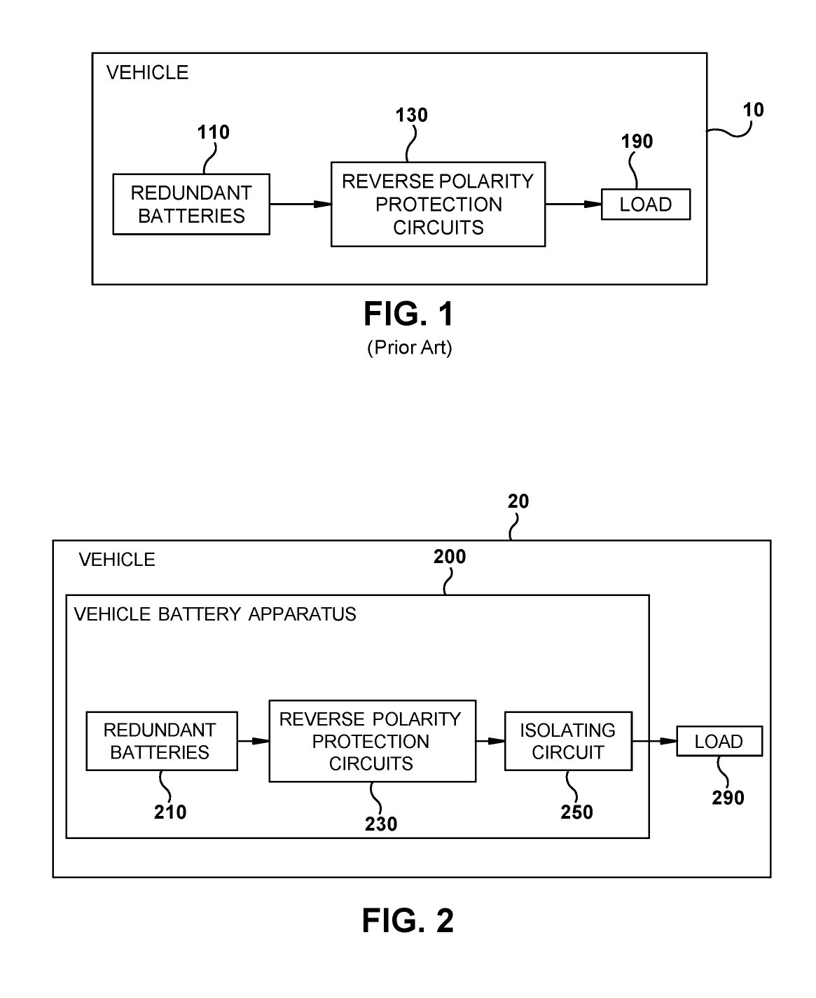

Referring to FIG. 1, a schematic block diagram is shown of a vehicle 10 embodying prior art redundant batteries 110 with reverse polarity protection circuits 130. The redundant batteries 110 act as a power source for a load 190. The reverse polarity protection circuits 130 allow forward current flow from the redundant batteries 110 through the reverse polarity protection circuits 130 to the load 190. The reverse polarity protection circuits 130 prevent reverse current flow from the load 190 through the reverse polarity protection circuits 130 to the redundant batteries 110.

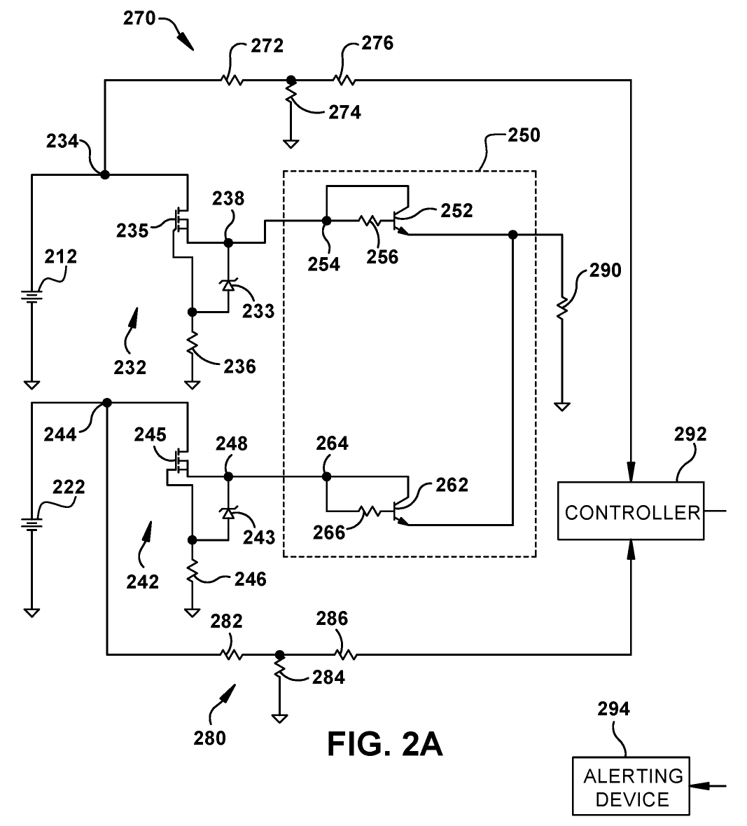

FIG. 2 is similar to FIG. 1, and shows a schematic block diagram of a vehicle 20 embodying an example vehicle battery apparatus 200 in accordance with the present disclosure. The vehicle battery apparatus 200 comprises redundant batteries 210 (i.e., two or more batteries) with reverse polarity protection circuits 230. Each battery of the redundant batteries 210 has an associated reverse polarity protection circuit of the reverse polarity protection circuits 230. The batteries of the redundant batteries 210 share the load. In the absence of a battery, the other one or more of the batteries take over.

The vehicle battery apparatus 200 also comprises an isolating circuit 250 that is connected between the reverse polarity protection circuits 230 and a load 290 that can be powered by the redundant batteries 210 as a power source. The load 290 may be any type of electrical load associated with the vehicle 20. It is conceivable that the load 290 may comprise a controller of the vehicle. The reverse polarity protection circuits 230 allow forward current flow from the redundant batteries 210 through the reverse polarity protection circuits 230 to the load 290. The reverse polarity protection circuits 230 prevent reverse current flow from the load 290 through the isolating circuit 250 and the reverse polarity protection circuits 230 to the redundant batteries 210.

In accordance with an aspect of the present disclosure, the isolating circuit 250 prevents current flow from a first battery of the redundant batteries 210 through the reverse polarity protection circuit associated with a second battery of the redundant batteries 210 when the second battery is disconnected from its associated reverse polarity protection circuit. Accordingly, the isolating circuit 250 prevents a voltage drop across the reverse polarity protection circuit associated with the second battery when the second battery is disconnected from the associated reverse polarity protection circuit, as will be described herein.

FIG. 2A shows a schematic circuit diagram of the vehicle battery apparatus 200 of FIG. 2 embodying the isolating circuit 250 in accordance with the present disclosure. As shown in FIG. 2A, the isolating circuit 250 includes a first switch 252 (e.g., a first transistor 252) in which emitter of the first transistor 252 is connectable to the load 290. Collector of the first transistor 252 is connected through a first resistor 256 to base of the first transistor 252 and to an output 238 of a first reverse polarity protection circuit 232. The isolating circuit 250 also includes a second switch 262 (e.g., a second transistor 262) in which emitter of the second transistor 262 is connectable to the load 290. Collector of the second transistor 262 is connected through a second resistor 266 to base of the second transistor 262 and to an output 248 of a second reverse polarity protection circuit 242. The reverse polarity protection circuits 230 shown in FIG. 2 comprise the first and second reverse polarity protection circuits 232, 242 shown in FIG. 2A.

The redundant batteries 210 shown in FIG. 2 comprise a first battery 212 and a second battery 222 shown in FIG. 2A. Output of the first battery 212 is connected to input of the first reverse polarity protection circuit 232, designated at junction point 234. Output of the second battery 222 is connected to input of the second reverse polarity protection circuit 242, designated at junction point 244.

The first reverse polarity protection circuit 232 includes a first Zener diode 233 that is connected with a first MOSFET transistor 235 and a resistor 236 as shown in FIG. 2A to provide the functionality of the first reverse polarity protection circuit 232. The first Zener diode 233 is connected to an input of the isolating circuit 250, designated at junction point 254. Similarly, the second reverse polarity protection circuit 242 includes a second Zener diode 243 that is connected with a second MOSFET transistor 245 and a resistor 246 as shown in FIG. 2A to provide the functionality of the second reverse polarity protection circuit 242. The second Zener diode 243 is connected to another input of the isolating circuit 250, designated at junction point 264. Structure and operation of the first and second reverse polarity protection circuits 232, 242 are known and conventional and, therefore, will not be described.

A first signal conditioning circuit 270 is coupled between a controller 292 and the input 234 of the first reverse polarity protection circuit 232. Similarly, a second signal conditioning circuit 280 is coupled between the controller 292 and the input 244 of the second reverse polarity protection circuit 242. Each of the first and second signal conditioning circuits 270, 280 comprises a number of resistors forming a voltage divider and current limiter. The first signal conditioning circuit 270 includes resistor 272 and resistor 274 which provide a voltage dividing function, and resistor 276 which provides a current limiting function. The second signal conditioning circuit 280 includes resistor 282 and resistor 284 which provide a voltage dividing function, and resistor 286 which provides a current limiting function.

The controller 292 may comprise any controller of the vehicle 20 (FIG. 2), or may comprise a dedicated controller. The controller 292 monitors the input 234 of the first reverse polarity protection circuit 232 and provides a first alert signal when the first battery 212 is disconnected (or the first battery 212 is missing) from the input 234 of the first reverse polarity protection circuit 232 and the input 234 of the first reverse polarity protection circuit 232 indicates zero volts or no voltage. Similarly, the controller 292 monitors the input 244 of the second reverse polarity protection circuit 242 and provides a second alert signal when the second battery 222 is disconnected (or the second battery 222 is missing) from the input 244 of the second reverse polarity protection circuit 242 and the input 244 of the second reverse polarity protection circuit 242 indicates zero volts or no voltage.

An alerting device 294 (e.g., a diagnostic tool) is located in a passenger compartment of the vehicle 20 and is arranged to provide a diagnostic trouble code when the controller 292 provides the first alert signal or the second alert signal. It is conceivable that the alerting device 294 comprises a lamp (e.g., a light emitting diode) that provides a visual indication of a fault. Alternatively, or in addition to a visual indication or a diagnostic trouble code, an exact indication (e.g., an error message) of the fault may be provided on the vehicle dashboard. Moreover, the first alert signal or the second alert signal may be communicated to other vehicle controllers or to a fleet controller at a remote location.

Although the above-description describes the controller 292 monitoring the input 234 of the first reverse polarity protection circuit 232 through the first signal conditioning circuit 270 and the input 244 of the second reverse polarity protection circuit 242 through the second signal conditioning circuit 280, it is conceivable that the controller 292 monitor the inputs 234, 244 directly without using either one of the first and second signal conditioning circuits 270, 280. Accordingly, the first and second signal conditioning circuits 270, 280 are optional.

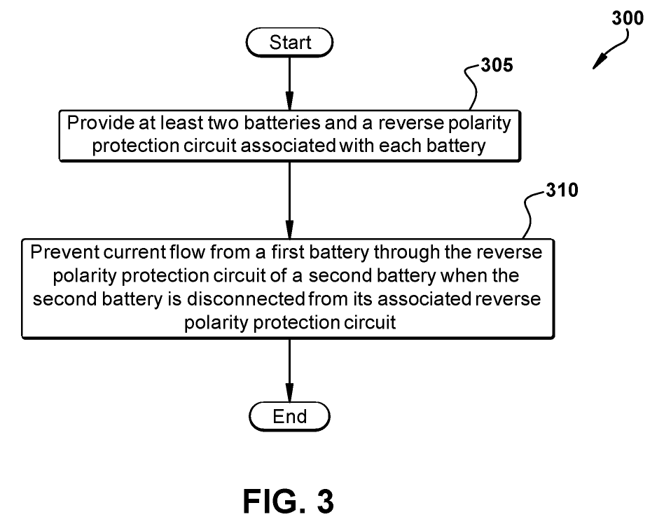

Referring to FIG. 3, a flow diagram 300 depicts a method of operating the vehicle battery apparatus 200 of FIG. 2 in accordance with an embodiment. In block 305, at least two batteries and a reverse polarity protection circuit with each battery are provided. Then in block 310, current flow from a first battery is prevented through the reverse polarity protection circuit of a second battery when the second battery is disconnected from its associated reverse polarity protection circuit. The process then ends.

In some embodiments, a voltage drop is prevented due to current being prevented from flowing through the reverse polarity protection circuit of the second battery when the second battery is disconnected from its associated reverse polarity protection circuit.

In some embodiments, the method further comprises monitoring the reverse polarity protection circuit associated with each battery for a voltage drop level of zero volts.

In some embodiments, the method further comprises setting a diagnostic trouble code when a voltage drop level associated with a reverse polarity protection circuit is at zero volts.

In some embodiments, the method is performed by a computer having a memory executing one or more programs of instructions which are tangibly embodied in a program storage medium readable by the computer.

A number of advantages are provided by the isolating circuit 250 disclosed herein. One advantage is that the vehicle battery apparatus 200 enables voltage of each battery of a multi-battery system to be measured independent of the voltage of another battery of the multi-battery system. By being able to measure the voltage of a battery independent of the voltage of another battery of the multi-battery system, false status of a battery is avoided. As an example, an incorrect voltage measurement reading of a battery due to current flow from another battery is avoided.

Another advantage is that the isolating circuit 250 allows forward current flow from the first and second batteries 212, 222 through the first and second reverse polarity protection circuits 232, 242 and prevents reverse current flow through the first and second reverse polarity protection circuits 232, 242 to the first and second batteries 212, 222. By preventing reverse current flow through the first and second reverse polarity protection circuits 232, 242, and thereby preventing voltage drops due to any reverse current flow, the voltage of each of the first and second batteries 212, 222 is accurately measured while maintaining redundancy of the first and second batteries 212, 222. Moreover, the isolating circuit 250 prevents current flow to the controller 292 that is monitoring battery state so that the controller 292 can correctly determine presence or absence of any one of the redundant batteries 210.

Yet another advantage is that the vehicle battery apparatus 200 including the isolating circuit 250 acts as a controlling device to provide an alert signal (e.g., a diagnostic trouble code) in response to detecting a voltage drop of zero volts (i.e., no voltage drop) across a reverse polarity protection circuit, which is indicative of a disconnected or missing battery. The diagnostic trouble code alerts a vehicle driver to take remedial action as needed. While the vehicle driver is being alerted, the dual batteries 212, 222 backup each other to ensure that the vehicle 20 continues to operate with minimal risk of any loss of power to vehicle electrical/electronic components.

Although the above description described use of the isolating circuit 250 in a vehicle have a vehicle driver, it is conceivable that the isolating circuit 250 be used in a semi-autonomous vehicle or a fully-autonomous vehicle.

Also, although the above description describes use of only two batteries with their respective reverse polarity protection circuits in a multi-battery system, it is conceivable that any number of batteries and reverse polarity protection circuits may be used. Moreover, it is conceivable that any type of battery and any type of reverse polarity protection circuit may be used.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant’s general inventive concept.

What is claimed is:

1. A vehicle battery apparatus for a vehicle having redundant batteries and a reverse polarity protection circuit associated with each battery, the vehicle battery apparatus comprising:
an isolating circuit coupled between the reverse polarity protection circuits and a load that can be powered with forward current flow from the redundant batteries through the reverse polarity protection circuits, wherein the isolating circuit is arranged to prevent reverse current flow through the reverse polarity protection circuits to the redundant batteries.

2. A vehicle battery apparatus according to claim 1, wherein the isolating circuit is arranged to prevent current flow to a controller that is monitoring battery state so that the controller can correctly determine presence or absence of any one of the redundant batteries.

3. A vehicle battery apparatus according to claim 1, wherein the isolating circuit includes (i) a first transistor in which emitter of the first transistor is connectable to the load and collector of the first transistor is connected to an output of a first reverse polarity protection circuit, and (ii) a second transistor in which emitter of the second transistor is connectable to the load and collector of the second transistor is connected to an output of a second reverse polarity protection circuit.

4. A vehicle battery apparatus according to claim 3, wherein the collector of the first transistor is connected through a first resistor to base of the first transistor, and the collector of the second transistor is connected through a second resistor to base of the second transistor.

5. A vehicle battery apparatus according to claim 4 further comprising:
a controller arranged to (i) monitor an input of the first reverse polarity protection circuit and provide a first alert signal when a first battery is disconnected from the input of the first reverse polarity protection circuit and the input of the first reverse polarity protection circuit indicates no voltage, and (ii) monitor an input of the second reverse polarity protection circuit and provide a second alert signal when a second battery is disconnected from the input of the second reverse polarity protection circuit and the input of the second reverse polarity protection circuit indicates no voltage.

6. A vehicle battery apparatus according to claim 5 further comprising:
a diagnostic tool located in a passenger compartment of the vehicle and arranged to provide a diagnostic trouble code when the controller provides the first alert signal or the second alert signal.

7. A vehicle battery apparatus comprising:
first and second batteries;
first and second reverse polarity protection circuits associated with the first and second batteries, respectively; and
an isolating circuit coupled between the first and second reverse polarity protection circuits, wherein the isolating circuit allows forward current flow from the first and second batteries through the first and second reverse polarity protection circuits and prevents reverse current flow through the first and second reverse polarity protection circuits to the first and second batteries.

8. A vehicle battery apparatus according to claim 7, wherein the isolating circuit includes (i) a first transistor in which emitter of the first transistor is connectable to a load and collector of the first transistor is connected to an output of the first reverse polarity protection circuit, and (ii) a second transistor in which emitter of the second transistor is connectable to the load and collector of the second transistor is connected to an output of the second reverse polarity protection circuit.

9. A vehicle battery apparatus according to claim 8, wherein the collector of the first transistor is connected through a first resistor to base of the first transistor, and the collector of the second transistor is connected through a second resistor to base of the second transistor.

10. A vehicle battery apparatus according to claim 9 further comprising:
a controller arranged to (i) monitor an input of the first reverse polarity protection circuit and provide a first alert signal when the first battery is disconnected from the input of the first reverse polarity protection circuit and the input of the first reverse polarity protection circuit indicates no voltage, and (ii) monitor an input of the second reverse polarity protection circuit and provide a second alert signal when the second battery is disconnected from the input of the second reverse polarity protection circuit and the input of the second reverse polarity protection circuit indicates no voltage.

11. A vehicle battery apparatus according to claim 10 further comprising:
a diagnostic tool located in a passenger compartment of the vehicle and arranged to provide a diagnostic trouble code when the controller provides the first alert signal or the second alert signal.

12. A vehicle battery apparatus according to claim 10 further comprising:
a lamp located in a passenger compartment of the vehicle and arranged to provide a visual indication of a fault when the controller provides the first alert signal or the second alert signal.

13. A vehicle battery apparatus according to claim 10 further comprising:
a first signal conditioning circuit coupled between the controller and the input of the first reverse polarity protection circuit; and
a second signal conditioning circuit coupled between the controller and the input of the second reverse polarity protection circuit.

14. A vehicle battery apparatus according to claim 13, wherein each of the first and second signal conditioning circuits comprises a number of resistors forming a voltage divider and current limiter.

15. A vehicle battery apparatus comprising:
first and second batteries;
first and second reverse polarity protection circuits associated with the first and second batteries, respectively; and
means for preventing current flow from each battery through the reverse polarity protection circuit of the other battery when the other battery is disconnected from its associated reverse polarity protection circuit.

16. A vehicle battery apparatus according to claim 15, wherein (i) the means comprises an isolating circuit coupled between the first and second reverse polarity protection circuits and a load that can be powered with forward current flow from the first and second batteries through the first and second reverse polarity protection circuits, and (ii) the isolating circuit is arranged to prevent reverse current flow through the first and second reverse polarity protection circuits to the first and second batteries.

17. A vehicle battery apparatus according to claim 16 further comprising:
a controller arranged to (i) monitor an input of the first reverse polarity protection circuit and provide a first alert signal when the first battery is disconnected from the input of the first reverse polarity protection circuit and the input of the first reverse polarity protection circuit indicates no voltage, and (ii) monitor an input of the second reverse polarity protection circuit and provide a second alert signal when the second battery is disconnected from the input of the second reverse polarity protection circuit and the input of the second reverse polarity protection circuit indicates no voltage.

18. A method of operating a vehicle battery apparatus having at least two batteries and a reverse polarity protection circuit associated with each battery, the method comprising:
preventing current flow from a first battery through the reverse polarity protection circuit of a second battery when the second battery is disconnected from its associated reverse polarity protection circuit.

19. A method according to claim 18, wherein preventing current flow from a first battery through the reverse polarity protection circuit of a second battery when the second battery is disconnected from its associated reverse polarity protection circuit includes:
preventing a voltage drop due to current being prevented from flowing through the reverse polarity protection circuit of the second battery when the second battery is disconnected from its associated reverse polarity protection circuit.

20. A method according to claim 18 further comprising:
monitoring the reverse polarity protection circuit associated with each battery for a voltage drop level of zero volts.

21. A method according to claim 20 further comprising:
setting a diagnostic trouble code when a voltage drop level associated with a reverse polarity protection circuit is at zero volts.

22. A method according to claim 18, wherein the method is performed by a computer having a memory executing one or more programs of instructions which are tangibly embodied in a program storage medium readable by the computer.
